(19) United States
(12) Patent Application Publication
(10) Pub. No.: US 2009/0034407 A1
(43) Pub. Date: Feb. 5, 2009

(54) Receiver-site restoration of clipped signal peaks

(76) Inventor: Lars Lindh, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/664,855

(22) PCT Filed: Oct. 6, 2004
(86) PCT No.: PCT/IB04/03248

§ 371 Date: Apr. 5, 2007

(51) Int. Cl. H04J 11/00

(52) U.S. Cl. 370/210

(57) ABSTRACT

A method, a computer program, a computer program product, a device and a system are shown for modulation symbol estimation, wherein a block of transmit modulation symbols is processed to obtain a transmit signal, wherein the transmit signal is transmitted over a transmission channel to obtain a receive signal, wherein the receive signal is processed to obtain a block of receive modulation symbols, wherein signal peaks of at least one of the transmit signal and said receive signal are clipped if the signal peaks exceed a clipping level, wherein a noise portion contained in the block of receive modulation symbols is estimated, wherein clipping-affected modulation symbol components are determined based on the estimated noise portion, wherein the determined clipping-affected modulation symbol components are added to the block of receive modulation symbols to obtain a block of refined receive modulation symbols, and wherein the transmit modulation symbols of the block of transmit modulation symbols are estimated from the block of refined receive modulation symbols.

### CROSS-REFERENCE TO RELATED APPLICATION

This application is the U.S. National Stage of International Application PCT/IB2004/003248 filed Oct. 6, 2004 and published in English on Apr. 13, 2006 under International Publication Number WO 2006/038052 A1.

### FIELD OF THE INVENTION

This invention relates to method, a computer program, a computer program product, a device and a system for modulation symbol estimation, in which system a block of transmit modulation symbols is processed to obtain a transmit signal, in which system said transmit signal is transmitted over a transmission channel to obtain a receive signal, in which system said receive signal is processed to obtain a block of receive modulation symbols, and in which system signal peaks of at least one of said transmit signal and said receive signal are clipped if said signal peaks exceed a clipping level.

### BACKGROUND OF THE INVENTION

Orthogonal Frequency Division Multiple Access (OFDM) is an effective transmission scheme for high data rate applications on frequency-selective transmission channels because inter-symbol interference arising from the frequency-selectivity of the transmission channel is effectively combated. OFDM thus has been selected as the transmission scheme in several standardization bodies like IEEE 802.11, 802.16 and HIPERMAN. Also future 4G mobile research projects consider OFDM as a prime candidate for the transmission scheme.

In OFDM, each transmit modulation symbol is assigned a fraction of the overall available transmission bandwidth, which fraction is denoted as a frequency sub-carrier, and the spacing of these sub-carriers is chosen so that the sub-carriers are orthogonal to each other. When the sub-carrier bandwidth is smaller than the coherence bandwidth of the transmission channel, the channel impulse response of each sub-carrier is frequency-flat and can be easily equalized.

Modulation of a block of transmit modulation symbols in an OFDM transmitter is accomplished via an Inverse Fourier Transformation (IFT), which accounts for the fact that the transmit modulation symbols are assigned to respective sub-carriers in the frequency domain and need to be transformed to the time domain to obtain an actual time-domain transmit signal. This time-domain transmit signal then is transmitted via a wire-bound or wire-less transmission channel to a receiver to obtain a time-domain receive signal. The receiver performs a Fourier Transformation (FT) on the receive signal to obtain a frequency-domain block of receive modulation symbols, wherein each receive modulation symbol in this block of receive modulation symbols is associated with one sub-carrier and is obtained from the transmission of a respective transmit modulation symbol over the respective sub-carrier transmission channel and the addition of a sub-carrier-specific noise portion.

When transforming a block of transmit modulation symbols via the IFT, each transmit modulation symbol is modulated onto a sub-carrier with a different center frequency, and subsequently all modulated sub-carriers are added to obtain said time-domain transmit signal. Although the transmit modulation symbols usually stem from a limited modulation symbol alphabet and, correspondingly, also the absolute values of the transmit modulation symbols stem from a limited set of absolute values, the addition of the modulated sub-carriers with different respective center frequencies causes large variance in the absolute values of the values of the time-domain transmit signal at different time instances. This variance increases with increasing numbers of sub-carriers. A measure for this variance is the Peak-to-Average-Power-Ratio (PAPR) of the transmit signal, which is computed as the power of the maximum value, i.e. the peak, in a transmit signal divided by the average power of all values in the transmit signal.

One of the biggest drawbacks of OFDM is the occurrence of high PAPRs in the transmit signal. This happens when the modulated sub-carriers combine constructively, and the PAPR can typically approach 10 dB, and theoretically, may achieve maximum values that are even much higher. If the power amplifier in the transmitter and/or receiver of an OFDM system can not handle peaks of the transmit and/or receive signal, for instance because a power amplifier with a limited dynamic range was chosen to reduce hardware costs, these peaks are simply clipped (cut off), resulting in a distortion of the transmit and/or receive signal, which degrades the estimation of the transmit modulation symbols at the receiver site, wherein this degradation can be modeled by an additional clipping noise in said receive signal.

Most of the prior art solutions concerning the problem of a high PAPR in OFDM systems concentrate on trying to avoid the high peaks in the transmit signal by exploiting some redundancy in the signal space. One well-known type of solution, the so-called selective mapping, generates several candidate waveforms representing the same transmit modulation symbols, measures the PAPR of each waveform and selects the one with the smallest PAPR.

In publication “Clipping Noise Mitigation for OFDM by Decision-Aided Reconstruction” by D. Kim and G. L. Stüber, IEEE Communications Letters, Vol. 3, No. 1, January 1999, a solution is proposed where clipping noise caused by signal clipping at the transmitter site is mitigated at the receiver. Based on the block of receive modulation symbols and the estimated sub-carrier transmission channels, this solution first determines an estimate of the block of transmit modulation symbols and an estimate of the block of clipping-affected transmit modulation symbols in the frequency domain and subsequently transforms both estimates to the time domain, thus obtaining an estimate of the transmit signal and the clipped transmit signal. Knowledge on the clipping level at the transmitter then is exploited to detect which values in the estimated transmit signal have been clipped, and the corresponding values in the estimated clipped transmit signal are then replaced by the values of the estimated transmit signal to obtain a refined estimated clipped transmit signal. This refined estimated clipped transmit signal then is transformed back to the frequency domain and used to create a refined block of receive modulation symbols, which is used as block of receive modulation symbols in the next iteration. With each iteration, thus the estimate of the block of transmit modulation symbols is improved.

However, this solution of Kim and Stüber processes an estimate of the time domain transmit signal in order to determine which values of the transmit signal have been clipped, and thus requires knowledge of the clipping level at the transmitter, which is generally implementation-dependent and thus differs from transmitter to transmitter. The use of different transmitter types in a system thus is aggravated or requires additional signaling of the clipping level from the transmitter to the receiver.

### SUMMARY OF THE INVENTION

In view of the above-mentioned problems, an improved method, computer program, computer program product, device and system for modulation symbol estimation are proposed.

It is proposed a method for modulation symbol estimation in a modulation symbol transmission system, in which system a block of transmit modulation symbols is processed to obtain a transmit signal, in which system said transmit signal is transmitted over a transmission channel to obtain a receive signal, in which system said receive signal is processed to obtain a block of receive modulation symbols, and in which system signal peaks of at least one of said transmit signal and said receive signal are clipped if said signal peaks exceed a clipping level, said method comprising estimating a noise portion contained in said block of receive modulation symbols; determining clipping-affected modulation symbol components based on said estimated noise portion; adding said determined clipping-affected modulation symbol components to said block of receive modulation symbols to obtain a block of refined receive modulation symbols; and estimating said transmit modulation symbols of said block of transmit modulation symbols from said block of refined receive modulation symbols.

Said transmit modulation symbols may for instance be phase- and/or amplitude-modulated modulation symbols, for instance 16 QAM (Quadrature Amplitude Modulation) symbols, which are obtained by mapping groups of transmit data bits onto transmit data symbols as prescribed by said phase- and/or amplitude modulation scheme.

Said transmit modulation symbols are to be transmitted from a transmitter to a receiver in a modulation symbol transmission system. Said modulation symbol transmission system may be wire-bound or wireless. Said modulation symbol transmission system may for instance be an Orthogonal Frequency Division Multiplex (OFDM) system.

Said block of transmit modulation symbols comprises a fixed amount of transmit modulation symbols, and this block is processed, for instance via an inverse Fourier transform as in an OFDM system, to produce a transmit signal. In this case, each transmit modulation symbol of said block of transmit modulation symbols is modulated onto a frequency sub-carrier, wherein each of said sub-carriers has a different frequency, and wherein the modulated sub-carriers are superposed to obtain said transmit signal. In an alternative embodiment of the present invention, said block of transmit modulation symbols may be processed by means of other transformations to obtain said transmit signal, for instance by means of a Hilbert transformation or wavelet transformation (or inverse transformations thereof), or by a spreading operation that spreads that block of transmit modulation symbols with a spreading code to obtain a spread-spectrum signal which may for instance be deployed in a Code Division Multiple Access (CDMA) system.

The transmit signal then is transmitted over said transmission channel to obtain a receive signal, wherein at a transmitter site, said transmission may comprise operations such as for instance insertion of training symbols for synchronization and channel estimation into said transmission signal, adding of a cyclic prefix, clipping of signal peaks, digital-to-analog conversion, frequency up-conversion to a Radio Frequency (RF), and transmission from a channel interface as for instance an antenna, and wherein at a receiver site, said transmission may comprise operations such as for instance reception at a channel interface, clipping of signal peaks, frequency down-conversion to an intermediate or base-band frequency, time and/or frequency synchronization, and removal of a cyclic prefix.

Said transmission channel contains the physical propagation channel between one or more physical transmission channel interfaces (for instance antennas) of a transmitter and one or more physical transmission channel interfaces (for instance antennas) of a receiver.

During said transmission, said clipped transmit signal may furthermore be subject to transmission noise, which comprises interference noise stemming from other signals and thermal noise, for instance thermal noise caused by the hardware components of a transmitter and/or receiver front-end.

In said modulation symbol transmission system, signal peaks of at least one of said transmit signal and said receive signal are clipped if said signal peaks exceed a clipping level. This may for instance occur due to a limited dynamic range of a power amplifier at said transmitter and/or of a front-end at said receiver. This clipping may for instance be described by setting the absolute value of said transmit/receive signal at a certain time instance equal to said clipping level if said absolute value of said transmit/receive signal at said time instance exceeds said clipping level, and preserving a phase of said transmit/receive signal at said certain time instance. Said clipping level, which is basically an absolute threshold value, may for instance be defined by an upper boundary of a dynamic range of the transmitter and/or receiver hardware. Clipping takes place in the time domain and can be described by an additional noise component, the clipping noise.

Said receive signal is processed to obtain a block of receive modulation symbols, for instance by means of a Fourier transformation as in an OFDM system. In an alternative embodiment of the present invention, said receive signal may be processed by means of other transformations to obtain said block of receive modulation symbols, for instance by means of a Hilbert transformation or wavelet transformation (or inverse transformations thereof) that cooperates with a transformation performed at the transmitter site, or by a de-spreading operation that de-spreads that receive signal with a spreading code.

Said receive modulation symbols then represent noisy, attenuated and phase-shifted versions of the transmit modulation symbols and may thus serve as a basis for the estimation of said transmit modulation symbols. Said estimates of said transmit modulation symbols then can be mapped into groups of receive data bits.

Said noise in said receive modulation symbols comprises transmission noise and furthermore clipping noise caused by clipping-affected modulation symbol components that result from the fact that peaks of the transmit and/or receive signal have been clipped.

According to the present invention, it is observed that the effect of clipping noise on the receive modulation symbols is of systematic nature and thus can be mitigated. To this end, a noise portion contained in said block of receive modulation symbols is estimated, clipping-affected modulation symbol components are determined from said estimated noise portion, and subsequently the clipping-affected modulation symbols components are added to said block of receive modulation symbols to obtain a block of refined receive modulation symbols, from which then said transmit modulation symbols can be estimated.

In an OFDM system, the determination of said clipping-affected modulation symbol components from said estimated noise portion may for instance be performed by determining the peaks of a time-domain representation of said estimated noise portion, and Fourier-transforming said peaks to obtain said clipping-affected modulation symbol components in the frequency domain. As the estimated noise portion is likely to comprise representations of transmission noise, clipping noise and estimation noise (caused during the estimation of the noise portion itself), the performance of the proposed solution improves at least with decreasing transmission noise.

In contrast to prior art, where clipped values in an estimate of the clipped transmit signal are determined and exchanged based on knowledge of the clipping level, and where this processed estimate of the clipped transmit signal then is used to obtain a refined block of receive modulation symbols from which said transmit modulation symbols can then be estimated, the present invention proposes to determine the clipping-affected modulation symbol components from an estimate of the noise portion contained in the block of receive modulation symbols without requiring any knowledge of the clipping level, and thus is independent of transmitter- or receiver-specific power amplifier implementations.

The clipping-affected modulation symbol components, when added to the block of receive modulation symbols, directly yield the refined block of modulation symbols from which said transmit modulation symbols can then be estimated. Therein, said block of refined receive data symbols represents a soft decision output, from which then said transmit modulation symbols can be estimated, for instance via hard decision. In this exemplary hard decision case, soft decision as for instance information related to the quality of the hard decision estimate is however not lost and can be further exploited when processing the estimated block of transmit modulation symbols, for instance when performing the receiver-end processing of a Forward Error Correction (FEC) technique such as convolutional or block coding.

According to an embodiment of the present invention, said block of transmit modulation symbols is inverse Fourier-transformed to obtain said transmit signal, and wherein said receive signal is Fourier-transformed to obtain said block of receive modulation symbols. Said data transmission system then may for instance represent an OFDM system.

According to an embodiment of the present invention, said block of transmit modulation symbols is inverse Fourier-transformed to obtain said transmit signal, and wherein said receive signal is Fourier-transformed and subsequently channel-corrected to obtain said block of receive modulation symbols.

In an OFDM system, said channel correction (or equalization) may attempt to remove the influence of the transmission channel between the transmitter and receiver from the block of modulation symbols that is output by the FT, for instance by applying a Zero-Forcing or Minimum-Mean-Square-Error criterion on each modulation symbol that is output by the FT. For instance, if a Zero-Forcing criterion is applied, each respective modulation symbol associated with a respective sub-carrier is divided by the transmission channel coefficient of this sub-carrier. The results then constitute the block of receive modulation symbols, which are then further processed to determine the clipping-affected modulation symbol components that are to be added to the block of receive modulation symbols to remove the impact of clipping of the transmit and/or receive signal.

According to an embodiment of the present invention, said steps of estimating a noise portion contained in said block of receive modulation symbols, determining clipping-affected modulation symbol components based on said estimated noise portion, and adding said determined clipping-affected modulation symbol components to said block of receive modulation symbols to obtain a block of refined receive modulation symbols are repeated in at least two iterations, wherein after each iteration, said block of refined receive modulation symbols serves as said block of receive modulation symbols for the next iteration, and wherein said block of transmit modulation symbols is estimated from that block of refined receive modulation symbols that is obtained in a last iteration of said at least two iterations.

Said iterative application of said method steps significantly increases the quality of the estimate of said block of transmit modulation symbols. In each iteration step, the block of refined receive modulation symbols contains a noise portion that is affected by less clipping noise, so that are more concise estimation of the noise portion, which sets out from this block of refined receive modulation symbols, is possible. The improved estimate of the noise portion then allows for a more concise detection and determination of the clipping-affected data symbol components, which in turn produces a block of even further refined receive modulation symbols as a basis for the next iteration.

According to an embodiment of the present invention, said step of estimating a noise portion contained in said block of receive modulation symbols comprises estimating said block of transmit modulation symbols from said block of receive modulation symbols, wherein said noise portion is estimated at least based on said estimated block of transmit modulation symbols and said block of receive modulation symbols.

In an OFDM system, said block of transmit modulation symbols may for instance be estimated by checking, for each sub-carrier, which candidate modulation symbol from a limited modulation symbol alphabet of said transmit modulation symbols minimizes the difference between a receive modulation symbol associated with said sub-carrier and the product of a transmission channel coefficient of said sub-carrier and said candidate modulation symbol, wherein said transmission channel coefficient characterizes the transmission channel of said sub-carrier and wherein said candidate symbol that minimizes said difference is considered as an estimated transmit modulation symbol with respect to said sub-carrier. If channel correction (equalization) has already been performed for the receive signal, it may not be necessary to consider the transmission channel coefficients, and then the candidate modulation symbol that minimizes the difference between the receive modulation symbol and the candidate modulation symbol is considered as estimated transmit modulation symbol with respect to said sub-carrier.

Said noise portion may then be estimated by subtracting said block of receive modulation symbols and said estimated block of transmit modulation symbols. However, when some of the transmit modulation symbols have been estimated incorrectly, said estimated noise portion no longer resembles the original noise portion contained in said block of receive modulation symbols, which only contains the representations of clipping and transmission noise. In contrast, the estimated noise portion then contains the representations of transmission noise, clipping noise and estimation noise. Particularly clipping noise and estimation noise may be reduced by iteratively executing the steps of the present invention.

According to an embodiment of the present invention, said estimating of said noise portion is further based on information on the transmission channel. This is particularly advantageous if no channel correction has been performed and thus knowledge of the transmission channel, for instance knowledge of the transmission channel coefficients of the sub-carriers in an OFDM system, may be required to accurately estimate said noise portion. Said information on said transmission channel may for instance be estimated by blind, semi-blind or non-blind channel estimation techniques, or may be known a-priori, in particular if the transmission channel is static.

According to an embodiment of the present invention, said step of determining clipping-affected modulation symbol components based on said estimated noise portion comprises inverse Fourier-transforming said estimated noise portion to obtain a transformed estimated noise portion; searching for at least one clipping peak in said transformed estimated noise portion; and if said at least one clipping peak has been found, Fourier-transforming said at least one clipping peak to obtain said clipping-affected modulation symbol components.

In an OFDM system, said noise portion contained in said block of receive modulation symbols is estimated in the frequency domain, so that said estimated noise portion represents a Fourier transformation of the sum of transmission noise and clipping noise, which both are generated in the time domain, plus an additional estimation noise, which is generated in the frequency domain and consists of a discrete peak for each transmit modulation symbol that was estimated incorrectly. It is thus instructive to perform an inverse Fourier-transformation on said estimated noise portion, which yields a transformed estimated noise portion. This transformed estimated noise portion then contains the time-domain transmission and clipping noise and an inverse Fourier transformation of said frequency-domain estimation noise. In the time domain, the clipping noise then basically contains the discrete clipping peaks that are caused by the clipping of the time-domain transmit and/or receive signal. These clipping peaks obey a substantially different probability distribution than the transmission noise (which for instance obeys a Gaussian distribution) and the inverse Fourier-transformed estimation noise, and thus may, with a high probability, be distinguished from transmission noise when being analyzed in the time domain.

In said transformed estimated noise portion, then at least one clipping peak is searched. This may for instance be accomplished by comparing all values of said transformed estimated noise portion to an absolute or relative threshold. It may be possible that only one clipping peak is searched for, for instance the largest clipping peak in the transformed estimated noise portion, or that a couple of clipping peaks is searched for, for instance two, three or more of the largest clipping peaks in said transformed estimated noise portion. If the method according to the present invention is performed in several iterations, searching for more than one clipping peak per iteration may significantly speed up the method. If several clipping peaks shall be detected, one respective threshold for each of said clipping peaks may be required.

Said found clipping peaks then are Fourier-transformed to obtain said clipping-affected modulation symbol components. Depending on the conciseness of the transformed estimated noise portion, transforming said clipping peaks from the time domain to the frequency domain to obtain said clipping-affected modulation symbol components in the frequency domain and adding said clipping-affected modulation symbol components to the block of refined receive signals may significantly remove the impact of the clipping of the transmit and/or receive signal that is represented by said clipping peak in said transformed estimated noise portion in all refined receive modulation symbols of said block of refined receive modulation symbols.

According to an embodiment of the present invention, said at least one clipping peak in said transformed estimated noise portion fulfils a condition that a ratio between the power of said value of said clipping peak and the average power of all values in said transformed estimated noise portion except said value of said clipping peak is larger than a pre-defined threshold value. In the calculation of said average power, also a couple of strong peaks of said transformed estimated noise portion may be excluded.

This condition can be easily applied to search for clipping peaks in said transformed estimated noise portion. The reliability of this condition may significantly increase with decreasing power of the transmission noise.

According to an embodiment of the present invention, said estimated noise portion contains representations of clipping noise that is caused by said clipping of said signal peaks, transmission noise that is added to said transmit signal during said transmission over said transmission channel, and estimation noise that stems from said estimation of said noise portion, wherein parameters related to the probability distributions of said clipping noise, said transmission noise and said estimation noise are estimated, and wherein said parameters are at least partially considered in said step of searching for said at least one clipping peak in said transformed estimated noise portion.

Said transmission noise, said clipping noise and said estimation noise may have significantly different probability distributions. Said parameters may for instance be moments of said probability functions or functions thereof, as for instance mean value and variance.

According to an embodiment of the present invention, each of said transmit modulation symbols is obtained by mapping a group of at least four transmit data bits to said transmit modulation symbol according to a phase and/or amplitude modulation scheme. The performance of the method according to the present invention may further increase in operating points where the power of the transmission noise is low compared to the power of the receive signal. Such operating points may for instance be faced in modulation symbol transmission systems that deploy higher-order modulation, such as 16-QAM or 64-QAM.

It is further proposed a computer program with instructions operable to cause a processor to perform the above-mentioned method steps.

It is further proposed a computer program product comprising a computer program with instructions operable to cause a processor to perform the above-mentioned method steps.

It is further proposed a device for modulation symbol estimation in a modulation symbol transmission system, in which system a block of transmit modulation symbols is processed to obtain a transmit signal, in which system said transmit signal is transmitted over a transmission channel to obtain a receive signal, in which system said receive signal is processed to obtain a block of receive modulation symbols, and in which system signal peaks of at least one of said transmit signal and said receive signal are clipped if said signal peaks exceed a clipping level, said device comprising means arranged for estimating a noise portion contained in said block of receive modulation symbols; means arranged for determining clipping-affected modulation symbol components based on said estimated noise portion; means arranged for adding said determined clipping-affected modulation symbol components to said block of receive modulation symbols to obtain a block of refined receive modulation symbols; and means arranged for estimating said transmit modulation symbols of said block of transmit modulation symbols from said block of refined receive modulation symbols.

According to an embodiment of the present invention, said device is a terminal of a wireless communication system or a part of said terminal.

According to an embodiment of the present invention, said device is a network element in a wireless communication system or a part of said network element.

It is further proposed a system for modulation symbol transmission, comprising a transmitter and a receiver, wherein said transmitter comprises means arranged for processing a block of transmit modulation symbols to obtain a transmit signal; and means arranged for transmitting said transmit signal over a transmission channel to said receiver; wherein said receiver comprises means arranged for receiving said transmit signal from said transmitter to obtain a receive signal; means arranged for processing said receive signal to obtain a block of receive modulation symbols; means arranged for estimating a noise portion contained in said block of receive modulation symbols; means arranged for determining clipping-affected modulation symbol components based on said estimated noise portion; means arranged for adding said determined clipping-affected modulation symbol components to said block of receive modulation symbols to obtain a block of refined receive modulation symbols; and means arranged for estimating said transmit modulation symbols of said block of transmit modulation symbols from said block of refined receive modulation symbols, and wherein signal peaks of at least one of said transmit signal and said receive signal are clipped if said signal peaks exceed a clipping level.

These and other aspects of the invention will be apparent from and elucidated with reference to the embodiments described hereinafter.

### BRIEF DESCRIPTION OF THE FIGURES

In the figures show:

FIG. 1: A schematic presentation of a system according to an embodiment of the present invention;

FIG. 2: a schematic presentation of the components of a transmitter according to an embodiment of the present invention;

FIG. 3: a schematic presentation of the components of a receiver according to an embodiment of the present invention;

FIG. 4: a schematic presentation of the components of a clipping-affected modulation symbol component estimator according to an embodiment of the present invention;

FIG. 5: a flowchart of a method for estimating modulation symbols according to an embodiment of the present invention;

FIG. 6: a flowchart of a method for searching clipping peaks in a transformed estimated noise portion according to an embodiment of the present invention;

FIG. 7: a set of diagrams illustrating a transformed estimated noise portion in different iterations of the method according to an embodiment of the present invention; and

FIG. 8: a diagram depicting the average Bit Error Ratio (BER) as a function of the average Signal-to-Noise Ratio for different numbers of iterations of the method of the present invention.

### DETAILED DESCRIPTION OF THE INVENTION

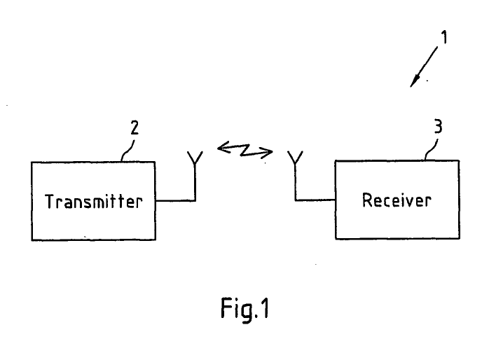

FIG. 1 depicts an Orthogonal Frequency Division Multiplex (OFDM) system 1 that comprises a transmitter 2 and at least one receiver 3. This system may for instance represent a Wireless LAN (W-LAN) according to IEEE standard 802.11, 802.16 or the HIPERMAN standard. Equally well, said system may represent a Digital Video Broadcasting Terrestrial (DVB-T) or Digital Audio Broadcasting System (DAB), or a 4G mobile radio system. The transmission channel between transmitter 2 and receiver 3 in FIG. 1 is exemplarily assumed to be a wireless transmission channel, but it should be noted that the present invention is equally well suited for deployment in systems that communicate via a wire-bound link, like for instance a cable or an optical fiber.

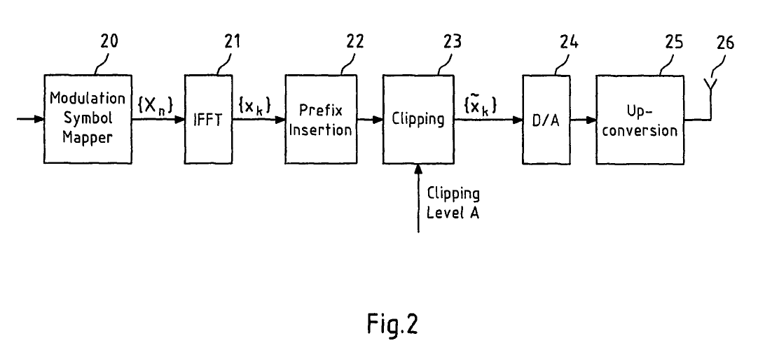

FIG. 2 depicts the main functional components of the transmitter 2 of FIG. 1. In the transmitter 2, transmit data bits stemming from an information source are mapped to a limited number of signal space constellations that are defined by a modulation scheme, for instance a phase and/or amplitude shift keying modulation technique, and that are represented by complex-valued transmit modulation symbols. As an example, 4 transmit data bits may be mapped to one transmit modulation symbol in a 16 Quadrature Amplitude Modulation (16-QAM) technique at a time. This mapping is performed in the modulation symbol mapper 20, which outputs transmit modulation symbols Xₙ that are organized in blocks of transmit modulation symbols {Xₙ} with n=0, . . . , N−1, i.e. one block of transmit modulation symbols comprises N transmit modulation symbols. Each transmit modulation symbol Xₙ of said block of transmit modulation symbols {Xₙ} is associated with one frequency sub-carrier, respectively, and said block of transmit modulation symbols {Xₙ} can thus be considered a frequency-domain block of transmit modulation symbols.

Said block of transmit modulation symbols {Xₙ} then is subject to an N-point Inverse Fast Fourier Transform (IFFT), which is particularly efficient if the number N of transmit modulation symbols per block is a power of 2. Said IFFT transforms said block of transmit modulation symbols into a time-domain transmit signal {xₖ} that comprises N discrete-time values x_{k′} by modulating each transmit modulation symbol Xₙ with n=0, . . . , N−1 onto a frequency sub-carrier with center frequency 2πn/N and subsequently sums up all modulated sub-carriers to obtain said transmit signal. Each discrete-time value xₖ of said transmit signal {xₖ} with k=0, . . . , N−1 then is given as

$${x}_{k} = \frac{1}{N} {\sum }_{n = 0}^{N - 1} {X}_{n} \cdot {e}^{j \cdot k \cdot \frac{2 π n}{N}} .$$

In an instance 22, then a cyclic prefix is added to said transmit signal {ₖ} in order to combat intersymbol interference, wherein said cyclic prefix may for instance be at least as long as a time-domain impulse response of the transmission channel between the transmitter and the receiver. For the sake of simplicity of presentation, the notation {xₖ} will also be used for the signal at the output of instance 22.

The transmit signal {xₖ} is then subject to clipping in a clipping instance 23, which may for instance represent a power amplifier with a limited dynamic range. The output of this clipping instance is a clipped transmit signal {\tilde{x}ₖ}, the values of which are given as

$${\tilde{x}}_{k} = \{ \begin{matrix}{x}_{k} & for \vert {x}_{k} \vert \leq A \\ A \cdot {e}^{j \cdot arg ( {x}_{k} )} & for \vert {x}_{k} \vert > A\end{matrix}$$

wherein A is the clipping level, and wherein arg(xₖ) denotes the phase of xₖ. Therein, it was exemplarily assumed that the clipping in clipping instance 23 is phase-preserving and that A is constant for the duration of a value of the transmit signal {xₖ}. It should be noted that the present invention is not restricted to application in systems where the clipping can be described by the above model. In fact, the present invention may also significantly improve the estimation of modulation symbols if the clipping level is not constant and if the clipping is not phase-preserving. Furthermore, the present invention is not restricted to deployment in systems where only signal peaks of the transmit signal are clipped. If clipping of signal peaks occurs at the receiver only (with respect to the signal peaks of the receive signal), which may for instance be the case if a cost-optimized receiver with a low resolution of the A/D-converter is used, or at both the transmitter and the receiver, according to the present invention, exactly the same methods as presented for the case of transmitter-site clipping can be applied.

Clipping of the transmit signal {xₖ} causes additional noise, so-called clipping noise, that degrades the estimation of the transmit modulation symbols at the receiver site. The power of the clipping noise can be calculated as

$${N}_{clip} = \frac{1}{{σ}^{2}} {\int }_{A}^{∞} r \cdot {{e}^{- \frac{{r}^{2}}{2 {σ}^{2}}} ( r - A )}^{2} d r ,$$

where 2σ² is the power of the transmit signal, wherein the PAPR equals A²/(2σ²), and wherein the transmit signal amplitude is considered Rayleigh-distributed.
Integration gives

N_{clip}=2σ²·(e^{-PAPR}−2\sqrt{PAPR·π}·Q(\sqrt{2·PAPR})).

In the frequency domain, the clipping noise is spread over all sub-carriers and may, from a frequency-domain perspective, be considered Gaussian.

For different PAPRs, the following clipping noise N_{clip} can be expected:

| PAPR (dB) | Clipping Noise N_{clip} (dB) |
|---|---|
| 3 | −16.7 |
| 4 | −19.7 |
| 5 | −23.3 |
| 6 | −27.6 |

For a PAPR of 4 dB, furthermore the following Signal-to-Noise ratio (S/N) degradations can be expected, wherein N denotes the average power of the transmission noise, which comprises thermal noise and interference noise, and wherein S is the average power of the receive signal.

| S/N (dB) | S/(N + N_{clip}) |
|---|---|
| 13 | 12.2 |
| 14 | 13.0 |
| 15 | 13.7 |
| 16 | 14.5 |
| 17 | 15.1 |
| 18 | 15.8 |
| 19 | 16.3 |

The degradations in the S/N caused by the clipping of the transmit signal thus are evident.

Turning back to FIG. 2, the clipped transmit signal {\tilde{x}ₖ} is then digital-to-analog converted in a D/A instance 24, subsequently frequency up-converted to a radio frequency in an up-conversion instance 25 and then radiated via a transmit antenna 26.

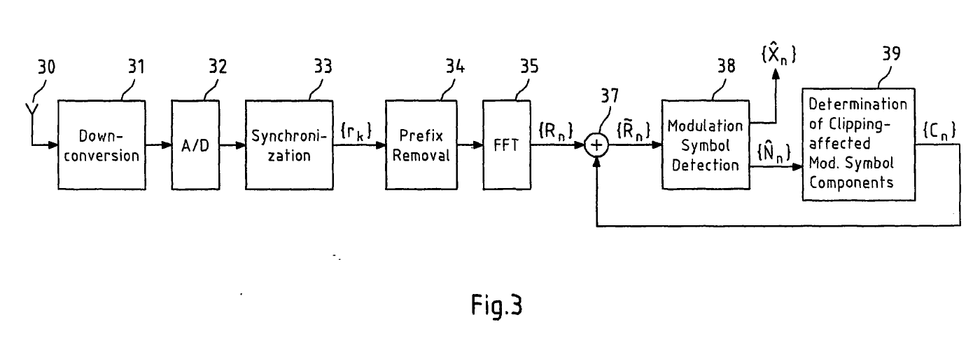

FIG. 3 depicts the main functional components of the receiver 3 of FIG. 1, which receives a representation of the signal transmitted by the transmitter 2, wherein this signal is filtered by the channel impulse response of the transmission channel between the transmitter 2 and the receiver 3 and is further subject to transmission noise. Said channel impulse response combines all effects of propagation attenuation, delay, phase shift, frequency shift and large- and small-scale fading that are imposed on said signal during transmission, and said transmission noise contains both the interference noise that is caused by signals impinging on the receive antenna from other transmitters and the thermal noise that is mainly caused by the hardware components in the front end of the receiver.

Said representation of the signal transmitted by the transmitter is received via receive antenna 30, subsequently frequency down-converted in down-conversion instance 31, analog-to-digital converted in A/D instance 32 and then synchronized in instance 33 to obtain a receive signal {rₖ}. A prefix associated with the cyclic prefix that was added at the transmitter 2 in instance 22 is then removed from the receive signal {rₖ} in instance 34, wherein the same notation {rₖ} is used for the receive signal at the input and the output of instance 34.

In instance 35, then a Fast Fourier Transform (FFT) is performed on the receive signal {rₖ}, which produces a block of receive modulation symbols {Rₙ} with n=0, . . . , N−1. The FFT analyzes the time-domain receive signal {rₖ} at each sub-carrier n=0, . . . , N−1 in the frequency domain.

Assuming ideal synchronization, said receive modulation symbols Rₙ in said block of receive modulation symbols {Rₙ} then can be expressed as

Rₙ=HₙXₙ+Nₙ,

wherein Hₙ is the transmission channel coefficient of sub-carrier n, and Nₙ is the frequency-domain noise portion with respect to sub-carrier n, which contains the effects of both transmission noise and clipping noise.

Without constraining the scope of the present invention, the sub-carrier transmission channel coefficients Hₙ are assumed to be perfectly known or estimated, for instance by means of blind, semi-blind or non-blind transmission channel estimation, in the sequel.

The block of receive modulation symbols as output by the FFT instance 35 then is fed into an adder 37, where clipping-affected modulation symbol components as determined by an iterative algorithm are added to said block of receive modulation symbols to mitigate the effect of clipping at the transmitter site. In a first iteration of this algorithm, said clipping-affected modulation symbol components are unknown and thus not added to said block of receive modulation symbols, so that the output of said adder 37 still produces only the block of receive modulation symbols {Rₙ}. In a modulation symbol detection instance 38, then the noise portion contained in said block of receive modulation symbols is estimated, for instance based on the transmission channel coefficients {Hₙ} of the sub-carriers and the block of receive modulation symbols {Rₙ}, as will be discussed in more detail below. Said estimated noise portion {\hat{N}ₙ} then is forwarded to an instance 39, where clipping-affected modulation symbol components {Cₙ} are determined, which are then added to said block of receive modulation symbols {Rₙ} in said adder 37 to obtain a block of refined receive modulation symbols {\tilde{R}ₙ}, which serves as an input to said modulation symbol detection instance 38 for the next iteration of said algorithm. If all iterations of said algorithm have been processed, or if said algorithm determines that no further iterations are required, said modulation symbol detection instance 38 produces an estimate {\hat{X}ₙ} of the transmit modulation symbols of the block of transmitted modulation symbols {xₙ} and outputs this estimate.

It should be noted that the present invention can equally well be applied if a channel correction (or equalization) instance is looped-in into the component chain of the receiver 3 of FIG. 3. This channel correction instance then may be located behind the FFT instance 35, may obtain the block of receive modulation symbols as input signal and output a block of channel-corrected receive modulation symbols. In this block of channel-corrected receive modulation symbols, each receive modulation symbol Rₙ of a sub-carrier n may for instance have been divided by the corresponding transmission channel coefficient Hₙ, so that the receive modulation symbols then have been equalized according to the Zero-Forcing equalization criterion. Alternatively, channel correction based on a Minimum-Mean-Square-Error criterion may be applied in said channel correction instance. Instead of the block of receive modulation symbols, then the block of channel corrected receive modulation symbols serves as an input to adder 37 and thus as an input for the iterative algorithm for modulation symbol estimation according to the present invention. The changes required in instance 38 to account for the channel correction will be discussed below.

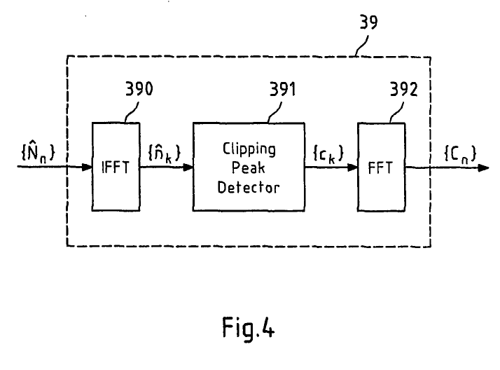

FIG. 4 depicts the main functional components of instance 39 of receiver 3 of FIG. 3. Instance 39 obtains the estimated noise portion {\hat{N}ₙ} as estimated by instance 38 of receiver 3 as input. This estimated noise portion {\hat{N}ₙ} comprises:
the Fourier-transformed transmission noise (i.e. the sum of thermal and interference noise) that is added to the transmit signal in the time domain and may for instance obey a Gaussian distribution in the time domain,
the Fourier-transformed clipping noise that stems from clipping of the transmit signal in the time domain and consists of discrete peaks in the time domain, and
the estimation noise that is caused during the estimation of the noise portion, wherein said estimation noise consists of discrete peaks in the frequency domain.

In IFFT instance 390, an IFFT is performed on this estimated noise portion {\hat{N}ₙ}. This IFFT transforms the frequency-domain estimated noise portion {\hat{N}ₙ} into a time-domain noise portion {\hat{n}ₖ}, which is denoted as transformed estimated noise portion. This transformed estimated noise portion {\hat{n}ₖ} contains:
the transmission noise,
the clipping noise, and
the inverse Fourier-transformed estimation noise.

As the discrete frequency-domain peaks of the estimation noise are smeared across the time domain by the inverse Fourier transformation, and as the transmission noise is usually of Gaussian type, the discrete peaks of the clipping noise should be clearly visible in the transformed estimated noise portion {\hat{n}ₖ}, so that both the clipping indices k′ where clipping in the transmit signal {xₖ} occurred and the corresponding clipping differences c_{k′}=x_{k′}−\tilde{x}_{k′} should be revealed. Of course, the accuracy of the determination of the clipping peaks based on the transformed estimated noise portion {\hat{n}ₖ} increases with decreasing power of the transmission noise and decreasing impact of the estimation noise.

Even when the transmission noise can not be neglected, the probability distribution of the transmission noise (for instance, white Gaussian noise), of the inverse Fourier-transformed estimation noise and of the clipping noise are generally significantly different so that a determination of the clipping index k′ and an estimate of the clipping difference c_{k′} is possible. This is performed in clipping peak detector 391.

The clipping differences c_{k′} then can be inserted into a discrete-time zero signal (comprising N time instances) at the positions prescribed by the corresponding clipping indices k′ to produce a clipping peak signal {cₖ}. This clipping peak signal may only comprise one clipping peak, if it is preferred to detect only one clipping peak per iteration, or several clipping peaks.

The influence of the time-domain clipping peaks in clipping peak signal {cₖ} on a block of modulation symbols in the frequency domain can be traced by performing an FFT on the clipping peak signal {cₖ} in FFT instance 392, which produces the clipping-affected modulation symbol components {Cₙ} at its output. Adding these clipping-affected modulation symbol components {Cₙ} to the block of receive modulation symbols {Rₙ} in adder 37 (FIG. 3) to obtain a block of refined receive modulation symbols {\tilde{R}ₙ} thus should mitigate or even completely remove the influence of the clipping of the transmit signal on the block of refined receive modulation symbols.

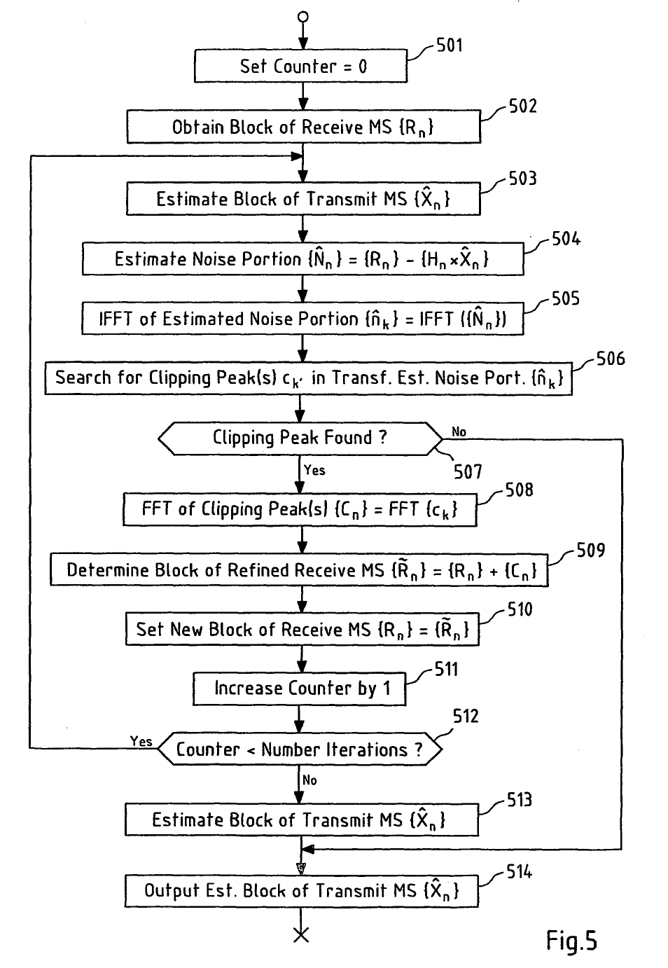

FIG. 5 is a flowchart 5 of a method for estimating modulation symbols according to an embodiment of the present invention. The steps of the flowchart may for instance be executed by the instances 37, 38 and 39 of the receiver 3 in FIG. 3. In the flowchart, the abbreviation “MS” is occasionally used for the modulation symbols.

In a first step 501, a counter variable is initialized to zero. In a second step 502, a block of receive modulation symbols {Rₙ} is obtained, for instance as output from the FFT instance 35 of receiver 3 (FIG. 3).

At least partially based on this block of receive modulation symbols, a block {\hat{X}ₙ} of transmit modulation symbols is estimated as a first raw estimate of the transmit modulation symbols in step 503. A hard decision estimate of the transmit modulation symbol may for instance be defined as

$${\hat{X}}_{n} = {min}_{{\hat{X}}_{n} ∈ \{ X \}} \vert {R}_{n} - {H}_{n} {X}_{n} \vert ,$$

wherein {X} denotes the limited modulation symbol alphabet of the transmit modulation symbols that is defined by the modulation scheme.

In a step 504, a frequency-domain noise portion is estimated based on the block of receive modulation symbols {Rₙ}, the block {\hat{X}ₙ} of estimated transmit modulation symbols and the transmission channel coefficients {Hₙ} for all N sub-carriers.

In step 505, this frequency-domain noise portion {\hat{N}ₙ} then is transformed into a transformed estimated noise portion {\hat{n}ₖ} in the time domain via an IFFT.

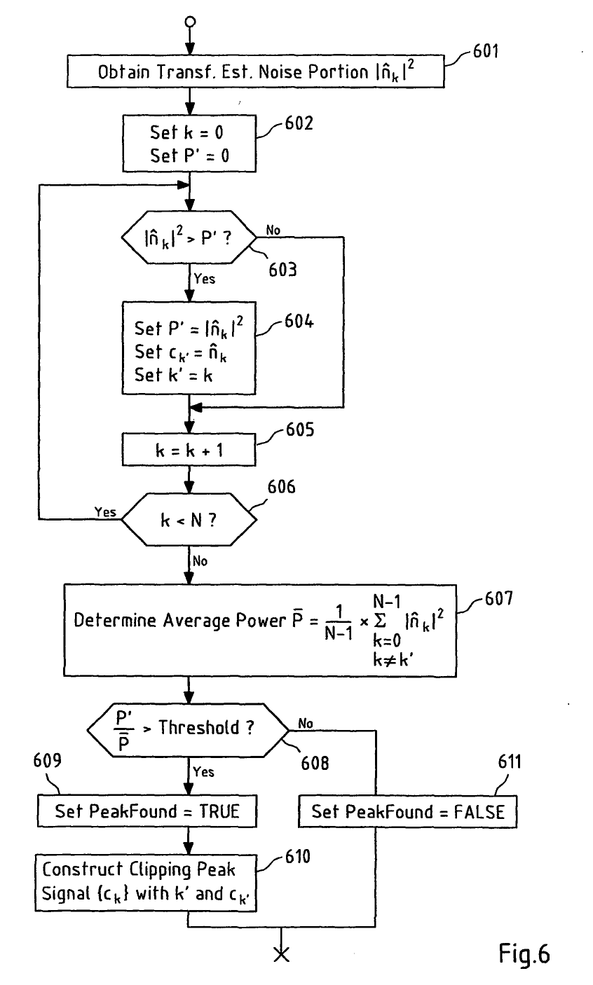

In step 506, one or more clipping peaks are searched for in the transformed estimated noise portion {\hat{n}ₖ}. This may for instance be accomplished by the algorithm that will be explained with reference to the flowchart 6 in FIG. 6 below. This algorithm may be further enhanced by estimating a clipping level from previous symbols and assuming that the clipping noise, the transmission noise and the inverse Fourier transformation of the estimation noise stem from different probability distributions. The parameters of one or both distributions could then be estimated and the probabilities of the source modulation symbols could be calculated. These probabilities could then form a basis for the search for clipping peaks in the transformed estimated noise portion {\hat{n}ₖ}.

Returning to the flowchart 5 of FIG. 5, in a step 507, it is checked if clipping peaks have been found (This may for instance be accomplished by checking for a variable PeakFound, which will be explained with reference to FIG. 6 below). If this is the case, the method proceeds to step 508, where an FFT of the clipping peak(s), contained in the clipping peak signal {cₖ} is performed to obtain clipping-affected modulation symbol components {Cₙ}.

In step 509, these clipping-affected modulation symbol components are added to the block of receive modulation symbols to obtain a block of refined receive data block symbols {\tilde{R}ₙ}.

In a step 510, then the block of receive modulation symbols {Rₙ} is replaced by the block of refined receive modulation symbols {\tilde{R}ₙ} and the counter variable is increased by one in step 511.

In step 512, it is checked if a pre-defined number of iterations has already been performed. If this is not the case, the method jumps back to step 503 and performs a new iteration, wherein now the block of refined receive modulation symbols is used as a basis. In this new iteration, a significantly improved estimate of the block of transmit modulation symbols can be expected already in step 503 as compared to the estimate of the preceding iteration, as the influence of at least one clipping peak has been removed from the block of receive modulation symbols. This improved estimate of the block of transmit modulation symbols leads to an estimate of the noise portion in step 504 that comprises less estimation noise as compared to the preceding iteration, and thus also the subsequent detection of clipping peaks in the transformed estimated noise portion (steps 505 and 506) is improved.

As the amount of estimation noise in the transformed estimated noise portion is reduced in each iteration step, it may be advantageous to detect only the strongest clipping peak in each iteration, based on a single threshold for this clipping peak (cf. step 608 of FIG. 6),

If the pre-defined number of iterations has been performed, the method executes step 513, wherein a final estimate {\hat{X}ₙ} of the block of transmit modulation symbols {xₙ} is determined, for instance in the same manner as in step 503. In both steps 503 and 513, thus a hard decision estimate can be determined as defined above. It should however be noted that the block of refined receive modulation symbols obtained in step 510 represents a soft decision output, i.e. when generating a hard decision estimate of the block of transmit modulation symbols, additionally soft decision information that is for instance represented by the difference Rₙ−Hₙ\hat{X}ₙ for each estimated transmit modulation symbol \hat{X}ₙ can be generated and used when further processing said estimated block of transmit modulation symbols (e.g. in the scope of an FEC technique).

This step 513 is also performed if it is determined in step 507 that no clipping peak could be found in the transformed estimated noise portion {\hat{n}ₖ}.

Finally, in a step 514, the final estimate {\hat{X}ₙ} of said block of transmit modulation symbols is output.

In the flowchart 5 of FIG. 5, it is assumed that no channel correction is performed after the FFT instance 35 in receiver 3 (FIG. 3). If this is however the case, i.e. if the receive signal is Fourier-transformed and subsequently channel-corrected to obtain a block of receive signals which then is used as an input signal for the method according to the present invention, steps 503, 504 and 513 have to be slightly modified to account for the channel correction. In particular, in step 503 and 514, the estimate of the transmit modulation symbol may be defined as

$${\hat{X}}_{n} = {min}_{{\hat{X}}_{n} ∈ \{ X \}} \vert {R}_{n} - {X}_{n} \vert ,$$

and in step 504, the noise portion may be estimated as {\hat{N}ₙ}={Rₙ}−{\hat{X}ₙ}. The other steps of the flowchart 5 of FIG. 5 remain basically unchanged. FIG. 6 depicts a flowchart of a method for searching clipping peaks in a transformed estimated noise portion according to an embodiment of the present invention, which may for instance be executed by the clipping peak detector 391 of receiver 3 (FIG. 4).

In a first step 601, the transformed estimated noise portion {\hat{n}ₖ} is obtained, for instance from the IFFT instance 390 of receiver 3 (FIG. 4).

In steps 602 to 606, the value \hat{n}_{k′} in said transformed estimated noise portion {\hat{n}ₖ} that has the largest power is determined, and the index k′, the value c_{k′}=\hat{n}_{k′} and the power P′=|\hat{n}_{k′}|² of this value are stored.

In a step 607, then the average power P̅ is computed by summing the squared absolute values of all N values of the transformed estimated noise portion except the value c_{k′}=\hat{n}_{k′} and normalizing to N−1. When determining the average power P̅, it may also be advantageous to estimate the number K_{clip} of clipping peaks in the transformed estimated noise portion {\hat{n}ₖ}, for instance by comparing each value of the transformed estimated noise portion against a certain threshold, and then to exclude the corresponding assumed K_{clip} clipping peaks when determining the average power. Then, instead of normalizing by the factor N−1, as depicted in step 605, normalization is performed with a factor N−K_{clip}, and a more concise average noise power that less depends on the power of the clipping peaks and more on the power of the transmission noise is obtained.

In step 608, it is then checked if a ratio between the power P′ of this value and the average power P̅ is larger than a pre-defined threshold. If this is the case, a clipping peak has been found, in a step 609, a variable PeakFound is set to TRUE, and the clipping peak, which is characterized by its index k′ and its value c_{k′}, is copied into a clipping peak signal {cₖ}. This clipping peak signal {cₖ} consists of N values equal to zero before the copying of the first clipping peak into it. The variable PeakFound may for instance be checked in step 507 of the flowchart 5 of FIG. 5 to determine if a peak has been found or not.

It should be noted that, among others situations, step 608 accounts for the situation where no clipping has occurred at the transmitter and prevents the algorithm to consider the value {c_{k′}} with maximum power, which then is actually only a maximum transmission noise peak, to be a clipping peak which needs to be corrected. However, even when the pre-defined threshold is too small to back up for this case and a maximum transmission noise peak is assumed to be a clipping peak, this peak will be spread across all sub-carriers in the frequency domain and will only cause a small correction of the block of receive modulation symbols, in particular for a high S/N value.

Finally, if it is detected in step 608, that no clipping peak has been found, the variable PeakFound is set to FALSE.

In the flowchart 6 of FIG. 6, it is exemplarily assumed that only one clipping peak is detected per iteration step. Of course, to speed up the method according to the present invention, more that one clipping peak could be detected by slightly modifying the flowchart 6.

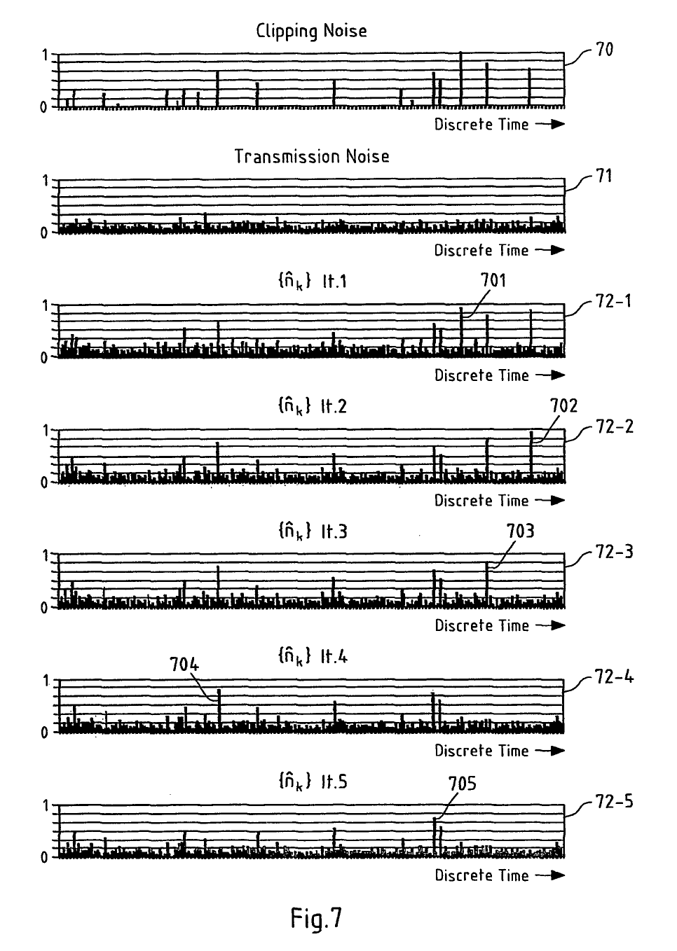

FIG. 7 contains a set of diagrams illustrating a transformed estimated noise portion in five different iterations of the algorithm for estimating modulation symbols according to the flowchart of FIG. 5. These diagrams set out from an S/N of 20 dB and a PAPR of 4 dB.

In the first diagram 70 of FIG. 7, the absolute value of the time-domain clipping noise is depicted in a normalized representation as a function of the discrete time instances of the transmit signal. The peaks in the clipping noise clearly indicate at which time instances clipping of the transmit signal {xₖ} occurred and to what extent the transmit signal was clipped.

The second diagram 71 of FIG. 7 depicts the absolute value of a realization of an Additive White Gaussian Noise (AWGN) process in the time domain that represents the transmission noise that is added to the transmit signal {xₖ} during its transmission over the transmission channel.

The third diagram 72-1 of FIG. 7 depicts a transformed estimated noise portion {\hat{n}ₖ} as determined in step 505 of a first iteration of the algorithm of FIG. 5. Said transformed estimated noise portion represents a summation of the clipping noise of the first diagram of FIG. 7, the AWGN transmission noise of the second diagram of FIG. 7, and the inverse Fourier-transformed estimation noise portion ({\hat{N}ₙ}−{Nₙ}) that is caused in the process of estimating the noise portion {\hat{N}ₙ} (see step 504 in the flowchart of FIG. 5) that serves as a basis for the determination of the transformed estimated noise portion {\hat{n}ₖ} (see step 505 in the flowchart of FIG. 5). As the difference between the noise portion and the estimated noise portion {\hat{N}ₙ}−{Nₙ} stems from erroneous estimation of the block of transmit modulation symbols {\hat{X}ₙ} (cf. step 504 of the flowchart of FIG. 5), said difference is discrete in the frequency domain, i.e. it only comprises peaks for sub-carriers for which transmit modulation symbols were erroneously estimated. Correspondingly, the inverse Fourier transformation causes these discrete peaks to be smeared across the time domain when the transformed estimated noise portion is determined by inverse Fourier-transforming the estimated noise portion and then causes a low-amplitude noise-like representation at each time instance.

As can be seen from the third diagram 72-1 of FIG. 7, the clipping peaks are thus still clearly visible in the transformed estimated noise portion, and it is possible, by applying the algorithm according to the flowchart of FIG. 6 on the transformed estimated noise portion {\hat{n}ₖ}, to detect both the index k′ and the value c_{k′} of the maximum clipping peak 701. This time domain clipping peak 701 then is transformed back to the frequency domain as a clipping-affected modulation symbol component, which restores those components of all transmit modulation symbols that were affected by the clipping of the transmit signal at that time instance k′.

The fourth diagram 72-2 of FIG. 7 depicts the transformed estimated noise portion {\hat{n}ₖ} as obtained in the second iteration of the algorithm. As can be readily seen by comparing diagrams 72-1 and 72-2, clipping peak 701 is no longer present in the transformed estimated noise portion {\hat{n}ₖ} of the second iteration, as the influence of this clipping peak 701 has been removed from the block of receive modulation symbols {Rₙ} when adding said clipping-affected modulation symbol components {Cₙ} to obtain said block of refined receive modulation symbols {\tilde{R}ₙ} in the preceding iteration. The refined block of receive modulation symbols {\tilde{R}ₙ} now serves as a basis for the estimation of the noise portion {\hat{N}ₙ} in the second iteration.

According to step 504 of the flowchart of FIG. 5, this estimation of the noise portion {\hat{N}ₙ} first requires an estimation of the block of transmit modulation symbols {\hat{X}ₙ}. This estimate {\hat{X}ₙ} can be expected to be less erroneous than its corresponding estimate in the first iteration, as the clipping noise has been reduced by removing clipping peak 701. This even holds although the determined value c_{k′} of the clipping peak 701 contains inevitable errors that are caused by the estimation noise. However, as the removal of the clipping peak 701 in the time domain only affects the time instance k′, also this inevitable error only affects this time instance k′, and, as can be seen by comparing diagrams 72-1 and 72-2 for time instance k′, the resulting transformed estimated noise portion value at time instance k′ is significantly smaller than the clipping peak at time instance k′ in diagram 72-1.

As the quality of the estimation of the noise portion {\hat{N}ₙ} depends on the quality of the estimation of the block of transmit modulation symbols {\hat{X}ₙ}, the improved estimate {\hat{X}ₙ} in the second iteration thus directly leads to an improved estimate {\hat{N}ₙ} and thus also to an improved transformed estimated noise portion {\hat{n}ₖ}, from which then again the strongest clipping peak 702 can be determined.

Summing up, it can thus be stated that in each iteration, the clipping noise in the block of receive modulation symbols is reduced, which allows for an improved estimation of the block of transmit modulation symbols. This improved estimate of the block of transmit modulation symbols then allows for an improved estimation of the noise portion, so that the impact of the estimation noise on the transformed estimated noise portion is reduced. Based on the improved transformed estimated noise portion, then an more concise detection of the strongest clipping peak is possible. This is the reason why the present invention is particularly advantageous when being applied in a couple of iterations.

Diagrams 72-3 to 72-5 depict the transformed estimated noise portion {\hat{n}ₖ} in the third, fourth and fifth iteration of the algorithm for estimating transmit modulation symbols, and the clipping peaks 703, 704 and 705 that are removed in the respective iterations. As can be readily seen by comparing the diagrams 72-1 to 72-5, with increasing number of iterations, the peaks of the transformed estimated noise portion are significantly reduced.

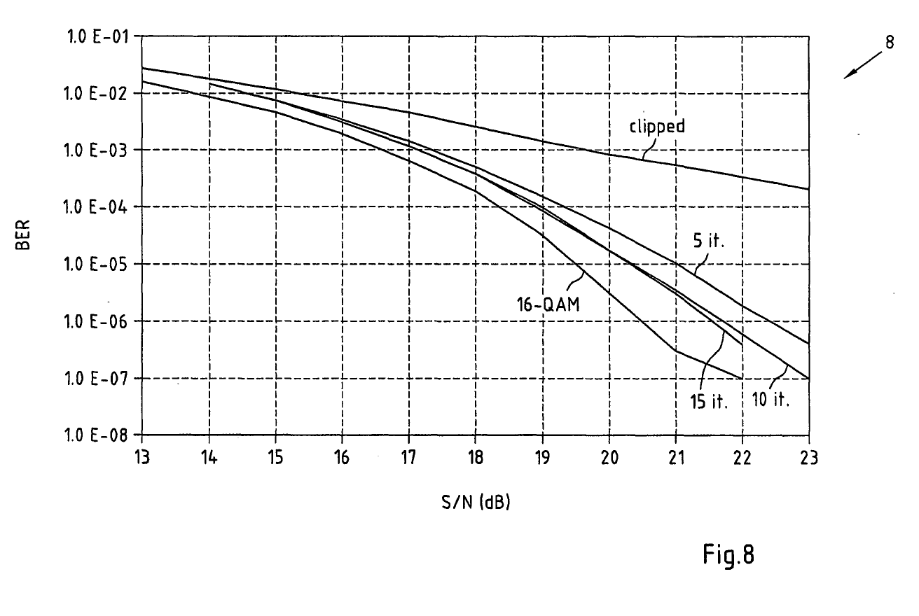

FIG. 8 is a diagram depicting the average Bit Error Ratio (BER) as a function of the average Signal-to-Noise Ratio S/N for different numbers of iterations of the method of the present invention. Therein, only the power of the transmission noise is considered in the S/N.

The lowermost curve represents the average BER that can be achieved with an OFDM system wherein no clipping of the transmit signal occurs, for instance due to a high quality power amplifier with a dynamic range that covers all occurring absolute values of the values of the transmit signal. The remaining four curves, in contrast, depict the BER when clipping with a PAPR of 4 dB occurs. Therein, the uppermost curve depicts the BER that can be achieved when no action is taken to mitigate the impact of the clipping on the quality of the estimated transmit modulation symbols. This would represent a result that can be achieved with the method of the present invention when setting the number of iterations to zero.

The three curves in between those two bounding curves represent the BER results achievable when the number of iterations of the method of the present invention is increased to 5, 10 and 15 iterations. It is readily seen that a huge improvement can be achieved as compared to the curve with zero iterations, in particular in the high S/N regime, which is for instance encountered in systems that deploy higher order modulation (such as for instance 16-QAM) and thus require operating points with sufficiently high S/N. It can further be deduced that performance can be increased by increasing the number of iterations form 5 to 10, but that further increasing the number of iterations beyond 10 does not yield significant performance gains.

The method according to the present invention thus represents a powerful means to combat the degradation of modulation symbol estimation quality in OFDM systems that suffer from clipping of the transmit and/or receive signal. It provides for an efficient and accurate reconstruction of the transmit modulation symbols and does not degrade subsequent receiver functions.

Furthermore, in contrast to prior art techniques, the method according to the present invention is blind and does not require knowledge of the transmitter and/or receiver clipping level at the receiver. In particular, no additional signaling between transmitter and receiver is required, and the method does not depend on pilots or any known sub-carriers. The method according to the present invention is completely independent of the implementation of the transmitter and/or receiver and thus can be used with any OFDM transmitter and/or receiver.

The S/N gains (compared to the S/N of a method that does not combat the degradations induced by clipping) that can be achieved for fixed average BER by the method according to the present invention can be efficiently exploited to reduce the transmission power in cost sensitive terminals, or to allow for an even lower clipping level, which also reduces the cost of the terminal. This can be achieved with only a small number of iterations, say 5, and thus represents a sustainable computational overhead with respect to modulation symbol estimation techniques that do not combat the degradations caused by clipping. Furthermore, the complete implementation of the method of the present invention may be performed in base-band and thus is particularly cost-efficient, as only software modifications may be required.

The invention has been described above by means of preferred embodiments. It should be noted that there are alternative ways and variations which are obvious to a skilled person in the art and can be implemented without deviating from the scope and spirit of the appended claims. In particular, the present invention is not restricted to OFDM systems, where the block of transmit modulation symbols is inverse Fourier-transformed to obtain said transmit signal, and wherein said receive signal is Fourier-transformed to obtain said block of receive modulation symbols. It may equally well be applied in systems that use different processing to obtain said transmit signal and said block of receive signals, for instance Hilbert or wavelet transforms or spreading and de-spreading. Furthermore, the present invention is not restricted to deployment in systems where the clipping takes place at the transmitter only, it adequately improves the performance of symbol estimation also in system where clipping takes place at the receiver or at both the transmitter and the receiver.

1. A method comprising:
estimating a noise portion contained in a block of receive modulation symbols obtained from a receive signal received over a transmission channel;
determining clipping-affected modulation symbol components based on an estimated noise portion, wherein said determining comprises inverse Fourier-transforming said estimated noise portion to obtain a transformed estimated noise portion, searching for at least one clipping peak in said transformed estimated noise portion, and if said at least one clipping peak has been found, Fourier-transforming said at least one clipping peak to obtain said clipping-affected modulation symbol components;
adding said determined clipping-affected modulation symbol components to said block of receive modulation symbols to obtain a block of refined receive modulation symbols; and
estimating transmit modulation symbols of a block of transmit modulation symbols from said block of refined receive modulation symbols.

2. The method according to claim 1, wherein said block of transmit modulation symbols is inverse Fourier-transformed to obtain a transmit signal containing said block of transmit modulation symbols transmitted over said transmission channel and received as said receive signal, and wherein said receive signal is Fourier-transformed to obtain said block of receive modulation symbols.

3. The method according to claim 1, wherein said block of transmit modulation symbols is inverse Fourier-transformed to obtain a transmit signal, and wherein said receive signal is Fourier-transformed and subsequently channel-corrected to obtain said block of receive modulation symbols.

4. The method according to claim 1, wherein said estimating a noise portion contained in said block of receive modulation symbols, determining clipping-affected modulation symbol components based on said estimated noise portion, and adding said determined clipping-affected modulation symbol components to said block of receive modulation symbols to obtain a block of refined receive modulation symbols are repeated in at least two iterations, wherein after each iteration, said block of refined receive modulation symbols serves as said block of receive modulation symbols for a next iteration, and wherein said transmit modulation symbols of said block of transmit modulation symbols are estimated from that block of refined receive modulation symbols that is obtained in a last iteration of said at least two iterations.

5. The method according to claim 1, wherein said estimating a noise portion contained in said block of receive modulation symbols comprises:
estimating said block of transmit modulation symbols from said block of receive modulation symbols, wherein said noise portion is estimated at least based on said estimated block of transmit modulation symbols and said block of receive modulation symbols.

6. The method according to claim 5, wherein said estimating of said noise portion is further based on information on said transmission channel.

7. The method according to claim 1, wherein said at least one clipping peak in said transformed estimated noise portion fulfils a condition that a ratio between power of a value of said clipping peak and an average power of all values in said transformed estimated noise portion except said value of said clipping peak is larger than a pre-defined threshold value.

8. The method according to claim 1, wherein said noise portion contained in said block of receive data symbols contains representations of clipping noise that is caused by clipping of signal peaks, transmission noise that is added to a transmit signal during transmission over said transmission channel, and estimation noise that stems from said estimation of said noise portion, wherein parameters related to probability distributions of said clipping noise, said transmission noise and said estimation noise are estimated, and wherein said parameters are at least partially considered in said searching for at least one clipping peak in said transformed estimated noise portion.

9. The method according to claim 1, wherein each of said transmit modulation symbols is obtained by mapping a group of at least four transmit data bits to a transmit modulation symbol according to a phase modulation scheme, an amplitude modulation scheme, or both.

10. A computer program stored on a computer readable medium with instructions operable to cause a processor to perform the method of claim 1.

11. A computer program product comprising a computer program stored on a computer readable medium with instructions operable to cause a processor to perform the method steps of claim 1.

12. Apparatus, comprising:
an estimating device arranged for estimating a noise portion contained in a block of receive modulation symbols;
a determining device arranged for determining clipping-affected modulation symbol components based on said estimated noise portion, wherein said determining comprises inverse Fourier-transforming said estimated noise portion to obtain a transformed estimated noise portion, searching for at least one clipping peak in said transformed estimated noise portion, and if said at least one clipping peak has been found, Fourier-transforming said at least one clipping peak to obtain said clipping-affected modulation symbol components;
a adding device arranged for adding said determined clipping-affected modulation symbol components to said block of receive modulation symbols to obtain a block of refined receive modulation symbols; and
an estimating device arranged for estimating transmit modulation symbols of a block of transmit modulation symbols from said block of refined receive modulation symbols.

13. The apparatus according to claim 12, wherein said apparatus is a terminal of a wireless communication system or a part of said terminal.

14. The apparatus according to claim 12, wherein said apparatus is a network element of a wireless communication system or a part of said network element.

15. A system comprising:
a transmit signal processor arranged for processing a block of transmit modulation symbols to obtain a transmit signal; and
a transmitter arranged for transmitting said transmit signal over a transmission channel to a receiver;
said receiver arranged for receiving said transmit signal from said transmitter to obtain a receive signal;
a receive signal processor arranged for processing said receive signal to obtain a block of receive modulation symbols;
an estimating device arranged for estimating a noise portion contained in said block of receive modulation symbols;
a determining device arranged for determining clipping-affected modulation symbol components based on said estimated noise portion, wherein said determining comprises inverse Fourier-transforming said estimated noise portion to obtain a transformed estimated noise portion, searching for at least one clipping peak in said transformed estimated noise portion, and if said at least one clipping peak has been found, Fourier-transforming said at least one clipping peak to obtain said clipping-affected modulation symbol components;
an adding device arranged for adding said determined clipping-affected modulation symbol components to said block of receive modulation symbols to obtain a block of refined receive modulation symbols; and
an estimating device arranged for estimating said transmit modulation symbols of said block of transmit modulation symbols from said block of refined receive modulation symbols,
and wherein signal peaks of at least one of said transmit signal and said receive signal are clipped if said signal peaks exceed a clipping level.
